(19) United States
(12) Patent Application Publication
(10) Pub. No.: US 2026/0311440 A1
(43) Pub. Date: Oct. 8, 2026

(54) VIRTUAL INTERACTION METHOD AND APPARATUS, DEVICE AND MEDIUM

(71) Applicant: Beijing Zitiao Network Technology Co., Ltd., Beijing (CN)

(72) Inventors: Lichen HUANG, Beijing (CN); Xiangyu HUANG, Beijing (CN); Liyue JI, Beijing (CN); Wenhui ZHAO, Beijing (CN); Linfeng PU, Beijing (CN)

(21) Appl. No.: 19/481,770

(22) PCT Filed: Apr. 25, 2024
(86) PCT No.: PCT/CN2024/089880

§ 371 Date: Nov. 5, 2025

(30) Foreign Application Priority Data
May 5, 2023 (CN) 202310501377.4

(51) Int. Cl. G06T 19/20; H04N 21/2187; H04N 21/478; H04N 21/4788; H04N 21/81

(52) U.S. Cl. CPC G06T 19/20; H04N 21/2187; H04N 21/4781; H04N 21/4788; H04N 21/816; G06T 2219/2004

(57) ABSTRACT

The present application provides a virtual interaction method and apparatus, a device and a medium. The method includes: displaying a video stream in a first interactive space, where the video stream includes a target interactive object; controlling at least one virtual object to enter a second interactive space according to interactive control information, where the second interactive space and the first interactive space are independent of each other; and performing, in the second interactive space, interaction between each virtual object and the target interactive object.

### CROSS-REFERENCE TO RELATED APPLICATION(S)

The present application is a U.S. National Stage application under 35 U.S.C. § 371 of International Application No. PCT/CN2024/089880, as filed on Apr. 25, 2024, which is based on and claims priority to Chinese Patent Application No. 202310501377.4, filed on May 5, 2023, titled “VIRTUAL INTERACTION METHOD AND APPARATUS, DEVICE AND MEDIUM”, the disclosure of the applications are incorporated herein by reference in their entireties.

### TECHNICAL FIELD

Embodiments of the present application relate to the technical field of human-computer interaction, and in particular, to a virtual interaction method and apparatus, a device and a medium.

### BACKGROUND

With the continuous improvement of the technical level, the application of Extended Reality (XR) technology is becoming more and more extensive, and has even become a new standard for the presentation of stage art. XR technology integrates various forms such as Virtual Reality (VR), Augmented Reality (AR) and Mixed Reality (MR), which can not only meet high-standard production requirements of stage scenes, but also bring immersive experience to users.

### SUMMARY

Embodiments of the present application provide a virtual interaction method and apparatus, a device and a medium.

In a first aspect, an embodiment of the present application provides a virtual interaction method, including:
displaying a video stream in a first interactive space, where the video stream includes a target interactive object;
controlling at least one virtual object to enter a second interactive space according to interactive control information, where the second interactive space and the first interactive space are independent of each other; and
enabling, in the second interactive space, interaction between each virtual object and the target interactive object.

In a second aspect, an embodiment of the present application provides a virtual interaction apparatus, including:
a display module, configured to display a video stream in a first interactive space, where the video stream includes a target interactive object;
a control module, configured to control at least one virtual object to enter a second interactive space according to interactive prompt information, where the second interactive space and the first interactive space are independent of each other; and
an interaction module, configured to enable, in the second interactive space, interaction between each virtual object and the target interactive object.

In a third aspect, an embodiment of the present application provides an electronic device, including:
a processor and a memory, where the memory is configured to store a computer program, and the processor is configured to invoke and run the computer program stored in the memory to execute the virtual interaction method according to the first aspect or various implementations thereof.

In a fourth aspect, an embodiment of the present application provides a computer-readable storage medium, configured to store a computer program, where the computer program causes a computer to execute the virtual interaction method according to the first aspect or various implementations thereof.

In a fifth aspect, an embodiment of the present application provides a computer program product including program instructions, where the program instructions, when running on an electronic device, cause the electronic device to execute the virtual interaction method according to the first aspect or various implementations thereof.

### BRIEF DESCRIPTION OF THE DRAWINGS

In order to illustrate the technical solutions in the embodiments of the present application more clearly, the drawings needed in the description of the embodiments will be briefly described below. Obviously, the drawings in the following description are only some embodiments of the present application, and other drawings may be obtained by those of ordinary skill in the art according to these drawings without creative effort.

FIG. 1 is a schematic flowchart of a virtual interaction method according to an embodiment of the present application;

FIG. 2 is a schematic diagram of adding a second interactive space on the basis of a first interactive space according to an embodiment of the present application;

FIG. 3 is a schematic flowchart of another virtual interaction method according to an embodiment of the present application;

FIG. 4a is a schematic diagram of displaying an interactive prompt pop-up window in a first interactive space according to an embodiment of the present application;

FIG. 4b is a schematic diagram of selecting an interactive confirmation option of “Go right away” in an interactive prompt pop-up window to interact with a streamer according to an embodiment of the present application;

FIG. 5a is a schematic diagram of another example of displaying an interactive prompt pop-up window in a first interactive space according to an embodiment of the present application;

FIG. 5b is a schematic diagram of selecting an interactive rejection option of “Give up” in an interactive prompt pop-up window to reject interacting with a streamer according to an embodiment of the present application;

FIG. 6a to FIG. 6f are schematic diagrams of selecting a target selection instruction and controlling a virtual object corresponding to the target selection instruction to enter a second interactive space according to an embodiment of the present application;

FIG. 7 is a schematic diagram of displaying identification information of “In interaction” on a virtual object participating in interaction in a first interactive space according to an embodiment of the present application;

FIG. 8 is a schematic flowchart of still another virtual interaction method according to an embodiment of the present application;

FIG. 9a is a schematic diagram of displaying a voice co-hosting image on an interactive screen in a second interactive space according to an embodiment of the present application;

FIG. 9b is a schematic diagram of highlighting a streamer who is performing voice co-hosting interaction on an interactive screen according to an embodiment of the present application;

FIG. 9c is a schematic diagram of another example of highlighting a streamer who is performing voice co-hosting interaction on an interactive screen according to an embodiment of the present application;

FIG. 10 is a schematic diagram of displaying an interactive image of each virtual object with a target interactive object on a first display screen according to an embodiment of the present application;

FIG. 11 is a schematic flowchart of still another virtual interaction method according to an embodiment of the present application;

FIG. 12a is a schematic diagram of displaying an abnormality prompt pop-up window in a second interactive space according to an embodiment of the present application;

FIG. 12b is a schematic diagram of a prompt image displayed when leaving a second interactive space according to an embodiment of the present application;

FIG. 12c is a schematic diagram of another example of displaying an abnormality prompt pop-up window in a second interactive space according to an embodiment of the present application;

FIG. 13 is a schematic diagram of a specific implementation according to an embodiment of the present application;

FIG. 14 is a schematic block diagram of a virtual interaction apparatus according to an embodiment of the present application; and

FIG. 15 is a schematic block diagram of an electronic device according to an embodiment of the present application.

### DETAILED DESCRIPTION OF EMBODIMENTS

The technical solutions in the embodiments of the present application will be described clearly and completely below with reference to the drawings in the embodiments of the present application. Obviously, the described embodiments are only a part of the embodiments of the present application, rather than all of the embodiments. All other embodiments obtained by those of ordinary skill in the art based on the embodiments of the present application without creative effort shall fall within the protection scope of the present application.

It should be noted that the terms “first” and “second” in the specification and claims of the present application and the above drawings are used to distinguish between similar objects, and are not necessarily used to describe a specific order or sequence. It should be understood that data used in this way may be interchanged under appropriate circumstances, so that the embodiments of the present application described herein may be implemented in a sequence other than those illustrated or described herein. In addition, the terms “include/comprise” and “have” and any variations thereof are intended to cover non-exclusive inclusion. For example, a process, method, system, product, or server that includes a series of steps or units is not necessarily limited to those steps or units that are clearly listed, but may include other steps or units that are not clearly listed or are inherent to these processes, methods, products, or devices.

In the embodiments of the present application, words such as “exemplary” or “for example” are used to represent examples, illustrations, or explanations. Any embodiment or solution described as “exemplary” or “for example” in the embodiments of the present application should not be interpreted as being more preferable or advantageous than other embodiments or solutions. Rather, the words “exemplary” or “for example” are intended to present related concepts in a specific way.

At present, in a virtual live streaming scenario, there are two virtual interaction manners between a viewer and a streamer. The first manner is bullet chat, specifically, the viewer inputs and sends chat content in a chat box, and then the streamer replies according to the chat content sent by the viewer. The second manner is gift interaction, specifically, the viewer gives the streamer a free or paid virtual gift.

In view of the problems in the two interaction manners between the viewer and the streamer in the virtual live streaming scenario at present, that is, the bullet chat or the gift interaction, such as monotonous interaction manners, poor interaction effect, and difficulty in motivating the interaction enthusiasm of the viewer, the present application provides a virtual interaction manner. By adding a second interactive space parallel to and independent of the first interactive space on the basis of the existing first interactive space, the viewer can perform immersive interaction with the streamer in the second interactive space, thereby improving the virtual interaction effect, and enhancing the interaction enthusiasm and interaction experience of the viewer.

In order to facilitate the understanding of the embodiments of the present application, before describing the various embodiments of the present application, some concepts involved in all the embodiments of the present application will be explained appropriately as follows.
1) Virtual Reality (VR) is a technology for creating and experiencing a virtual world, and a virtual environment is generated by computing, which is multi-source information (the virtual reality mentioned in this document at least includes visual perception, and may also include auditory perception, tactile perception, motion perception, and even gustatory perception, olfactory perception, etc.), to realize integrated and interactive simulation of 3D dynamic scenery and entity behavior of the virtual environment, so that the user is immersed in the simulated virtual reality environment, to realize the application of various virtual environments such as maps, games, videos, education, medical treatment, simulation, cooperative training, sales, assisting manufacturing, maintenance, and repair.
2) A virtual reality device (VR device) is a terminal for realizing the effect of virtual reality, which can usually be provided in the form of glasses, a head-mounted display (HMD), contact lenses, etc., to realize visual perception and other forms of perception. Certainly, the implementation form of the virtual reality device is not limited thereto, and the virtual reality device can be further miniaturized or enlarged according to actual needs.

In some embodiments, the virtual reality device described in the embodiments of the present application may include, but is not limited to, the following types.
2.1) A PC virtual reality (PCVR) device performs related computing of virtual reality functions and data output using a PC, and an external PC virtual reality device uses data output by the PC to realize the effect of virtual reality.
2.2) A mobile virtual reality device supports setting a mobile terminal (such as a smart phone) in various manners (such as a head-mounted display provided with a dedicated card slot), and performing, by the mobile terminal, related computing of virtual reality functions and outputting data to the mobile virtual reality device through a wired or wireless connection with the mobile terminal, for example, watching a virtual reality video through an APP of the mobile terminal.
2.3) An all-in-one virtual reality device is provided with a processor for performing related computing of virtual functions, and thus has independent virtual reality input and output functions, without a need to connect to a PC or a mobile terminal, and has high freedom of use.
3) Augmented Reality (AR) is a technology for calculating camera pose parameters of a camera in the reality world (or three-dimensional world, real world) in real time in a process of acquiring images by the camera, and adding a virtual element on the images acquired by the camera according to the camera pose parameters. The virtual element includes, but is not limited to, an image, a video, and a three-dimensional model. The objective of the AR technology is to sleeve the virtual world on the reality world on a screen for interaction.
4) Mixed Reality (MR) is a simulated setting that integrates sensory input (for example, a virtual object) created by a computer with sensory input from a physical setting or a representation thereof. In some MR settings, the sensory input created by the computer may be adapted to changes in the sensory input from the physical setting. In addition, some electronic systems for presenting the MR setting may monitor orientation and/or position relative to the physical setting, so that the virtual object can interact with a real object (that is, a physical element from the physical setting or a representation thereof). For example, the system may monitor motion, so that a virtual plant looks stationary relative to a physical building.
5) Extended Reality (XR) refers to all real and virtual combined environments and human-computer interaction generated by computer technology and wearable devices, which includes various forms such as Virtual Reality (VR), Augmented Reality (AR) and Mixed Reality (MR).
6) A virtual scene (also referred to as a virtual space) is a virtual scene displayed (or provided) when an application is run on an electronic device. The virtual scene may be a simulated environment of the real world, or a semi-simulated and semi-fictitious virtual scene, or a purely fictitious virtual scene. The virtual scene may be any of a two-dimensional virtual scene, a 2.5-dimensional virtual scene, or a three-dimensional virtual scene, and the dimension of the virtual scene is not limited in the embodiments of the present application. For example, the virtual scene may include the sky, the land, the ocean, etc., and the land may include environmental elements such as the desert and the city.
7) A virtual object is an object that interacts in the virtual scene, and is controlled by a user or a robot program (for example, a robot program based on artificial intelligence) and is capable of standing still, moving, and performing various behaviors in the virtual scene.

After introducing some concepts involved in the embodiments of the present application, a virtual interaction method and apparatus, a device and a medium provided by the embodiments of the present application will be described in detail below with reference to the drawings.

FIG. 1 is a schematic flowchart of a virtual interaction method according to an embodiment of the present application. The virtual interaction method provided by the present application may be executed by a virtual interaction apparatus. The virtual interaction apparatus may be composed of hardware and/or software, and may be integrated in an electronic device. In the embodiments of the present application, the electronic device may be any hardware device capable of providing a virtual space. Exemplarily, the electronic device may be, but is not limited to, a VR device, an AR device, an MR device, an XR device, etc. The type of the electronic device is not specifically limited in the present application.

As shown in FIG. 1, the method may include the following steps.
S101, displaying a video stream in a first interactive space, where the video stream includes a target interactive object.

In the embodiment of the present application, the first interactive space may be understood as a first virtual space, and the first virtual space may be a virtual scene simulated by an electronic device for a certain live streaming scene selected by any streamer. For example, when the streamer needs to build a live streaming scene of a rainforest, the electronic device builds a corresponding virtual live streaming scene according to this type as the first interactive space in the present application.

A video stream of the streamer side may be displayed in the first interactive space, and the video stream of the streamer side is preferably a live video stream in the present application. In addition, the live video stream at least includes the target interactive object. In the present application, the target interactive object may be understood as a streamer. For example, the target interactive object is a performer in a concert or the like.

Correspondingly, when the live video stream of the streamer side is displayed in the first interactive space, the first interactive space may be understood as a virtual live streaming room where the streamer is located.

It should be understood that a live streaming room refers to a social network platform, an instant messaging platform, or the like, where a large number of network users are gathered together. The user and the streamer enter the live streaming room by logging in a client, and the user exists as a member in the live streaming room. The same live streaming room includes members with various identities, such as the viewer. The user and the streamer can enter or exit the live streaming room.

Exemplarily, the user A selects any target live streaming room from a plurality of live streaming rooms displayed on a display screen of the electronic device through a controller such as a handle, and after entering the target live streaming room as a viewer, the user A can watch a performance of the streamer in the target live streaming room.
S102, controlling at least one virtual object to enter a second interactive space according to interactive control information, where the second interactive space and the first interactive space are independent of each other.

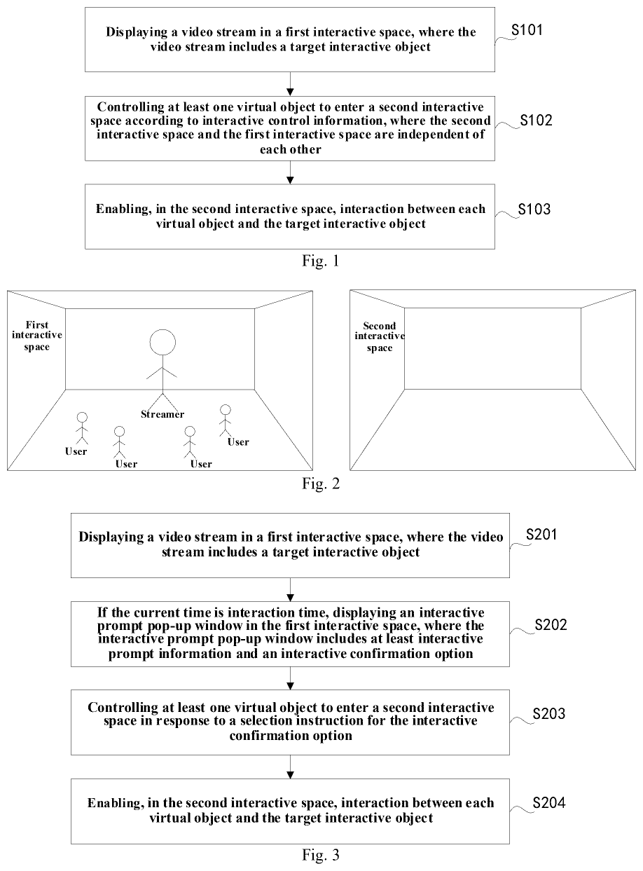

The interaction manner between a traditional user (viewer) and a streamer is generally bullet chat or gift interaction. However, since the above two interaction manners are relatively monotonous, it is difficult to motivate the interaction enthusiasm of the user. Therefore, in the present application, a new virtual space (the second interactive space) parallel to and independent of the first interactive space is added on the basis of the first interactive space, as shown in FIG. 2. Furthermore, the second interactive space is used as an independent interactive space for implementing virtual interaction, so that the user and the streamer can perform various interactions in this independent interactive space, thereby enriching the interaction manners between the user and the streamer, and improving the enthusiasm of interaction between the user and the streamer.

It should be understood that the creation process of the second interactive space is similar to the creation process of the first interactive space. Exemplarily, the second interactive space may be created by default while the first interactive space is created by the streamer, which will not be described in detail here.

Generally, the streamer can make the live streaming content more interesting by interacting with the viewer in the live streaming process. Therefore, in the live streaming process, the streamer can send an interaction invitation to the viewer in the live streaming room, to invite any viewer to interact, or the viewer in the live streaming room can also actively send an interaction application to the streamer, to apply for interacting with the streamer.

In some embodiments, the manner for the streamer to establish the interactive connection with the viewer may include, but is not limited to, the following manners.

### The First Manner

The streamer can set at least one interactive section in the live streaming process. In addition, whenever the interactive section is reached, an interactive prompt pop-up window can be displayed in the live streaming room, so that the user can participate in the interaction with the streamer based on the interactive prompt pop-up window.

The specific implementation process of participating in the interaction by the user based on the interactive prompt pop-up window may be triggering a confirmation option in the interactive prompt pop-up window, so that a virtual object (such as a virtual character, Avatar) corresponding to the user enters the second interactive space dedicated to various interactions, thereby interacting with the streamer in the second interactive space.

In the present application, the virtual object corresponding to each user in the live streaming room may be automatically configured by the electronic device according to the personal information of the user when the user enters the live streaming room. For example, when the user S enters a certain live streaming room, it is acquired that the gender of the user S in the personal information is male, and a male virtual object is configured for the user S according to the male gender. For another example, when the user W enters a certain live streaming room, it is acquired that the gender of the user W in the personal information is female, and a female virtual object is configured for the user W according to the female gender.

In addition, the user may also create a virtual object that meets his/her personalized needs through a virtual object creation function provided by the electronic device, which is not specifically limited in the present application.

It should be understood that there may be a plurality of users in a live streaming room. Therefore, when the user interacts with the streamer based on the interactive prompt pop-up window displayed in the live streaming room, the number of users participating in the interaction may be at least one.

### The Second Manner

In the live streaming process of the streamer, an interactive control, such as a co-hosting interactive control, will be displayed in the live streaming room. If any user wants to interact with the streamer, the user can send an interaction application to the streamer by triggering the co-hosting interactive control in the live streaming room. When the streamer passes the interaction application, the virtual object corresponding to the user who sends the interaction application will enter the second interactive space dedicated to various interactions, thereby interacting with the streamer in the second interactive space.

It should be noted that, in addition to the users who establish the interactive connection with the streamer in the live streaming room where the streamer is located, there are other users (that is, users who do not establish the interactive connection with the streamer). Therefore, when controlling the virtual object corresponding to the user who establishes the interactive connection with the streamer to enter the second interactive space, the switching operation may not be performed on the interactive space where the streamer is located, that is, the streamer still stays in the first interactive space, so that other users can continue to watch the performance of the streamer in the first interactive space.

In addition, since the user who enters the second interactive space needs to interact with the streamer, in the present application, a real-time image of the streamer may be acquired by using a first camera in the first interactive space, and the real-time image is sent to the second interactive space. Furthermore, the real-time image of the streamer is displayed in the second interactive space, so that each virtual object in the second interactive space can perform various interactions with the streamer based on the real-time image of the streamer.

The first camera in the first interactive space may be understood as a camera for implementing virtual interaction, and the first camera may be a 2D camera or other types of cameras, which will not be limited here.
S103, enabling, in the second interactive space, interaction between each virtual object and the target interactive object.

After at least one virtual object enters the second interactive space, each virtual object can interact with the target interactive object (streamer). In the present application, the interaction may be voice co-hosting interaction or video co-hosting interaction.

The voice co-hosting interaction is mainly performed by means of voice call. The video co-hosting interaction is performed by means of voice and real-time image. That is, in the voice co-hosting interaction, only voice data of both parties in the interaction can be heard, but real-time images of both parties in the interaction cannot be seen, while in the video co-hosting interaction, not only the voice data of both parties in the interaction can be heard, but also the real-time images of both parties in the interaction can be seen.

In the video co-hosting interaction, not only the voice data of both parties in the interaction can be heard, but also the real-time images of both parties in the interaction can be seen. Therefore, in the interaction manner of video co-hosting interaction, each virtual object may further perform different types of interaction with the target interactive object.

In some embodiments, the different types of interaction may include at least one of talent interaction and game interaction.

The talent interaction may include, but is not limited to, the streamer and each virtual object singing the same song in chorus, or the streamer and each virtual object dancing together.

The game interaction may include, but is not limited to, guessing the song by looking at the mouth shape, guessing the name of the song by listening to the prelude, and playing idiom solitaire.

According to the technical solutions provided in the embodiments of the present application, the video stream is displayed in the first interactive space, and at least one virtual object is controlled to enter the second interactive space according to the interactive control information, and then each virtual object performs interaction with the target interactive object in the second interactive space. In the present application, by adding an independent second interactive space on the basis of the first interactive space, the viewer can perform immersive interaction with the streamer in the independent second interactive space, thereby enriching the virtual interaction manners, improving the virtual interaction effect, and enhancing the interaction enthusiasm and interaction experience of the viewer.

On the basis of the above embodiments, further explanation and illustration will be made to controlling at least one virtual object to enter the second interactive space according to the interactive control information in the present application, which is described in detail with reference to FIG. 3.

As shown in FIG. 3, the method may include the following steps.
S201, displaying a video stream in a first interactive space, where the video stream includes a target interactive object.
S202, if the current time is interaction time, displaying an interactive prompt pop-up window in the first interactive space, where the interactive prompt pop-up window includes at least interactive prompt information and an interactive confirmation option.

In some embodiments, before starting the live streaming, the streamer can preset at least one interactive section, and an interaction start time and an interaction end time will be set for each interactive section. Therefore, the users in the live streaming room can interact in an orderly manner according to the preset interactive section, and the duration of the live streaming can be better controlled.

After setting the interactive section, the streamer can start live streaming, and in the live streaming process, the electronic device will detect in real time whether the current time reaches the interaction start time of the preset interactive section. If the current time is the interaction start time, the interactive prompt pop-up window is displayed in the live streaming room (that is, the first interactive space) where the streamer is located, so that the users in the live streaming room can select whether to interact with the streamer based on the interactive prompt pop-up window.

The interactive prompt pop-up window includes interactive prompt information, an interactive confirmation option, and an interactive rejection option. Therefore, the user located in the live streaming room can participate in the interaction with the streamer by triggering the interactive confirmation option, or can give up the interaction with the streamer by triggering the interactive rejection option.

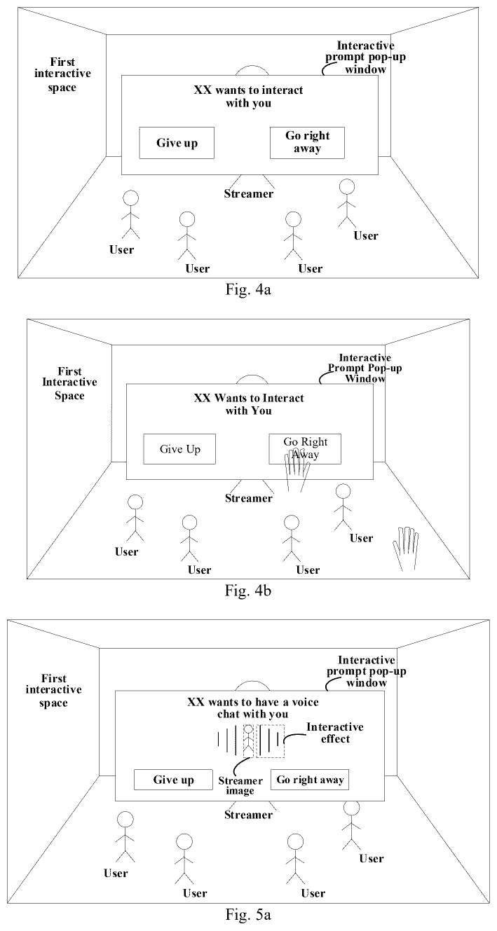

Exemplarily, as shown in FIG. 4a, the interactive prompt pop-up window displayed in the first interactive space includes interactive prompt information of “XX wants to interact with you”, an interactive confirmation option of “Go right away”, and an interactive rejection option of “Give up”. If the user W and the user T in the first interactive space want to participate in the interaction with the streamer, the user W and the user T can select the interactive confirmation option of “Go right away” to interact with the streamer respectively by means of a controller such as a handle, gesture, or voice, as shown in FIG. 4b.

For another example, as shown in FIG. 5a, the interactive prompt pop-up window displayed in the first interactive space includes interactive prompt information of “XX wants to have a voice chat with you”, an interactive confirmation option of “Go right away”, an interactive rejection option of “Give up”, a streamer image, and an interactive dynamic effect. If the user XX in the first interactive space does not want to participate in the interaction with the streamer, the user XX selects the interactive rejection option of “Give up” by means of a controller such as a handle or voice to reject interacting with the streamer, as shown in FIG. 5b. The streamer image may be a real image of the streamer, or a virtual streamer image created based on the streamer, which will not be specifically limited here. In addition, the interactive dynamic effect may be a ripple dynamic effect or other dynamic effects for establishing the interactive connection, which will not be limited here.
S203, controlling at least one virtual object to enter the second interactive space in response to a selection instruction for the interactive confirmation option.
S204, enabling, in the second interactive space, interaction between each virtual object and the target interactive object.

In some embodiments, whether the selection instruction for the interactive confirmation option in the interactive prompt pop-up window is acquired from any user in the first interactive space is detected. If the selection instruction for the interactive confirmation option is detected, it is determined that the user who sends the selection instruction wants to interact with the streamer. At this time, the virtual object corresponding to the user may be controlled to enter the second interactive space, thereby implementing the interaction between the streamer and the virtual object in the second interactive space.

Considering that the duration of a live streaming is limited, in order to ensure the normal performance of the streamer on the basis of realizing the interaction between the streamer and the user, in the present application, when controlling at least one virtual object to enter the second interactive space in response to the selection instruction for the interactive confirmation option, there is need to control the number of virtual objects entering the second interactive space, so as to ensure that the duration of interaction between the streamer and all virtual objects entering the second interactive space does not exceed the duration preset for the interactive section. The number of virtual objects entering the second interactive space may be flexibly adjusted according to the duration of the interactive section preset by the streamer, for example, 1, 3, or 4.

Based on the above reasons, in the present application, before controlling at least one virtual object to enter the second interactive space according to the acquired selection instruction for all interactive confirmation options, firstly, the target selection instruction is selected from all acquired selection instructions according to a selection rule. Secondly, the target selection instruction is responded to, and the virtual object corresponding to the target selection instruction is controlled to enter the second interactive space. Furthermore, the virtual object that enters the second interactive space can interact with the streamer.

In the present application, the selection rule may be any strategy or algorithm for selecting the target selection instruction from the acquired selection instructions, which will not be specifically limited here. For example, the target selection instruction is selected according to preset identification information, or the target selection instruction is selected according to a preset ID, which will not be specifically limited here. The identification information may be understood as information that uniquely determines the identity of the user, such as a user name, a user contact phone number, or the like. The preset ID may be an identity card number of the user or the like.

In some embodiments of the present application, the target selection instruction is selected from all acquired selection instructions according to the selection rule, which may be achieved by determining whether the virtual object identification corresponding to each selection instruction is a preset identification. If the virtual object identification corresponding to any selection instruction is the preset identification, it is determined that the selection instruction is the target selection instruction. If the virtual object identification corresponding to any selection instruction is not the preset identification, it is determined that the selection instruction is not the target selection instruction.

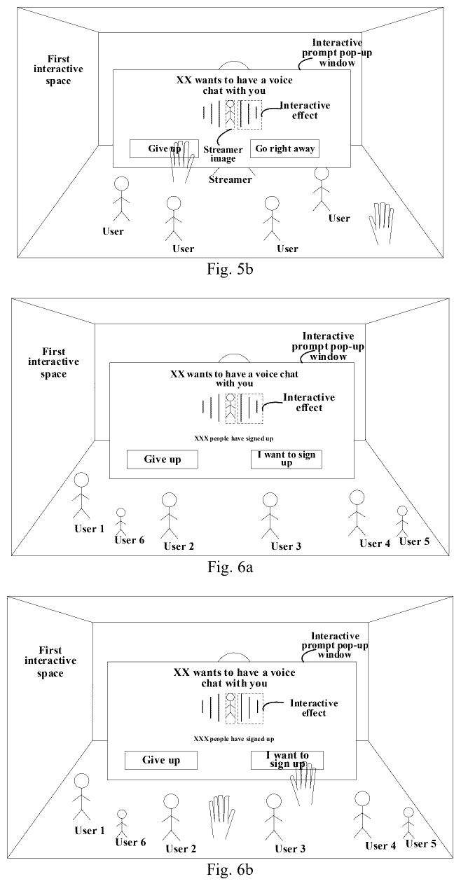

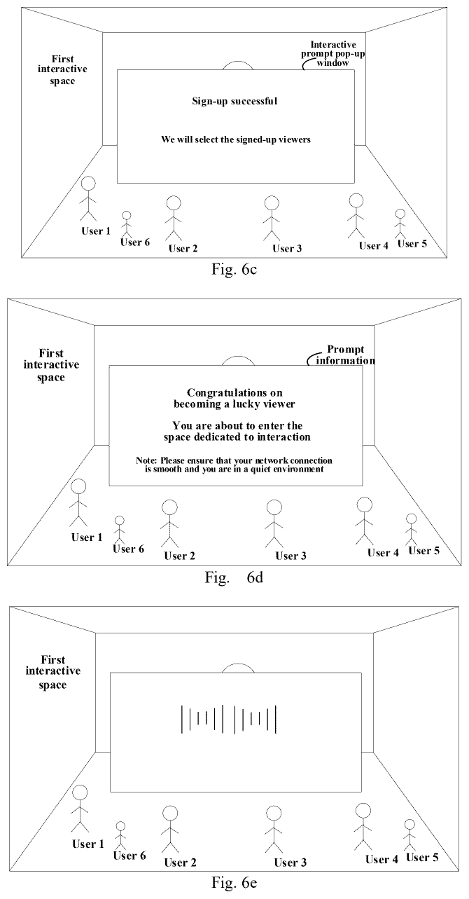

In order to more clearly illustrate the process of selecting the target selection instruction from all selection instructions and controlling the virtual object corresponding to the target selection instruction to enter the second interactive space, the following description will be given with reference to FIG. 6a to FIG. 6f as specific examples.

Specifically, it is assumed that the interactive prompt pop-up window displayed in the first interactive space includes interactive prompt information of “XX wants to have a voice chat with you”, an interactive confirmation option of “I want to sign up”, an interactive rejection option of “Give up”, a streamer image, an interactive dynamic effect, and dynamic prompt information of “XXX people have signed up”, as shown in FIG. 6a. The dynamic prompt information of “XXX people have signed up” will present a dynamic change effect with the change of the number of people who sign up, and the update frequency of the dynamic change effect can be flexibly set according to the live streaming delay requirement. If the live streaming delay requirement is low, the update can be performed every 5 seconds, and if the live streaming delay requirement is high, the update can be performed every 1 second, which will not be specifically limited in the present application.

As shown in FIG. 6b, the user 1, the user 2, the user 3, the user 4, the user 5, and the user 6 in the first interactive space all click the interactive confirmation option of “I want to sign up” to send the selection instruction for the interactive confirmation option of “I want to sign up” to the electronic device. When the interactive confirmation option of “I want to sign up” is clicked, the electronic device and/or a controller such as a handle will output vibration feedback to the user, so as to remind the user that the interactive confirmation option of “I want to sign up” has been selected through the vibration feedback.

In addition, when the electronic device acquires the above selection instruction, prompt information of “Sign-up successful” and “We will select the signed-up viewers, and the result will be notified later” may be displayed in the interactive prompt pop-up window in the first interactive space, as shown in FIG. 6c. In order to avoid the problem that the prompt information is displayed in the first interactive space for a long time, which will block the performance of the streamer, in the present application, the prompt information may be controlled to disappear after being displayed for a preset duration, so as to ensure that the user can completely watch the performance of the streamer, and avoid the problem of poor viewing experience caused by long-time blocking. In the present application, the preset duration may be flexibly set according to the live streaming requirements, for example, 2 seconds or 3 seconds.

If in the preset interactive section, at most 4 users can be interacted with, and the selection rule is to select the target selection instruction according to the preset user name (user nickname), the respective user names of the user 1, the user 2, the user 3, the user 4, the user 5, and the user 6 are compared with the preset user name in the selection rule. If the respective user names of the user 1, the user 3, the user 4, and the user 5 are the preset user name, it is determined that the selection instructions corresponding to the user 1, the user 3, the user 4, and the user 5 are the target selection instructions. Then, prompt information of “Congratulations on becoming a lucky viewer” and “You are about to enter the interactive space dedicated to interaction”, and a note of “Please ensure that your network connection is smooth and you are in a quiet environment” are displayed in the first interactive spaces corresponding to the user 1, the user 3, the user 4, and the user 5 respectively, as shown in FIG. 6d. When the display of the above prompt information and the note reaches the preset duration, the prompt information and the note are controlled to disappear.

As shown in FIG. 6e, after the prompt information and the note disappear, a space switching dynamic effect with a preset duration, such as a dynamic effect of opening and closing eyes or a dynamic effect of loading, may be presented in the first interactive space. When the display duration of the space switching dynamic effect reaches a preset duration, the second interactive space will appear in front of the virtual objects corresponding to the user 1, the user 3, the user 4, and the user 5 respectively, that is, the user 1, the user 3, the user 4, and the user 5 enter the second interactive space, as shown in FIG. 6f. Furthermore, the user 1, the user 3, the user 4, and the user 5 can perform various interactions with the streamer.

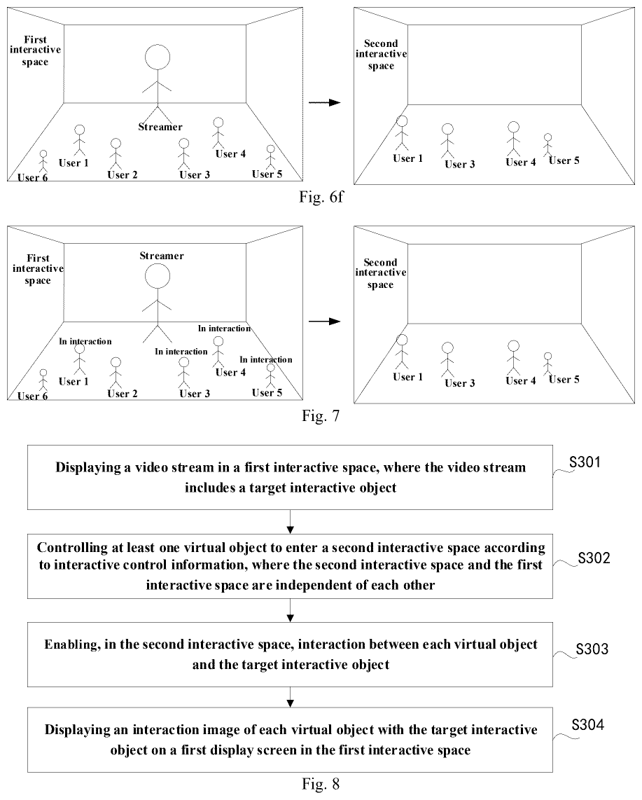

It should be noted that, after controlling at least one virtual object to enter the second interactive space, in some embodiments, the identification information of “In interaction” is also displayed on the corresponding virtual object in the first interactive space, so that the user in the first interactive space can know which users are interacting with the streamer, for example, as shown in FIG. 7.

In addition, the second interactive space can support the interaction between the user and the streamer, and such interaction is different from the conventional bullet chat and gift giving manners in the first interactive space. Therefore, in the present application, the interaction function in the second interactive space can be limited, so as to distinguish the interaction in the second interactive space from the conventional interaction manners in the first interactive space. For example, in the second interactive space, the user is only provided with the authority to switch on and off the microphone and switch on and off the camera. In addition, the authority to switch on and off the microphone and switch on and off the camera can also be uniformly managed by the streamer side, so as to avoid some virtual objects from making improper remarks or making indecent actions, thereby ensuring that the whole live streaming process can be carried out smoothly.

According to the technical solutions provided in the embodiments of the present application, the video stream is displayed in the first interactive space, and at least one virtual object is controlled to enter the second interactive space according to the interactive control information, and then each virtual object performs interaction with the target interactive object in the second interactive space. By adding an independent second interactive space on the basis of the first interactive space, the viewer can perform immersive interaction with the streamer in the independent second interactive space, thereby enriching the virtual interaction manners, improving the virtual interaction effect, and enhancing the interaction enthusiasm and interaction experience of the viewer.

In an optional implementation of the present application, it is considered that there are other users in the first interactive space who do not participate in the interaction with the streamer. Therefore, in order to enable these other users to see not only the content of interaction between the streamer and the user, but also the performance image of the streamer intuitively, in some embodiments of the present application, a first display screen is provided in the first interactive space. Therefore, the interaction image of each virtual object with the target interactive object in the second interactive space is displayed through the first display screen. The virtual interaction method provided in the embodiments of the present application will be further described below with reference to FIG. 8.

As shown in FIG. 8, the method may include the following steps.
S301, displaying a video stream in a first interactive space, where the video stream includes a target interactive object.
S302, controlling at least one virtual object to enter a second interactive space according to interactive control information, where the second interactive space and the first interactive space are independent of each other.
S303, enabling, in the second interactive space, interaction between each virtual object and the target interactive object.

The virtual object in the second interactive space can perform co-hosting interaction with the target interactive object, specifically, video co-hosting interaction or voice co-hosting interaction (voice chat interaction). Therefore, after at least one virtual object is controlled to enter the second interactive space, in the present application, a third display screen (interactive screen) can further be displayed in the second interactive space, and the co-hosting image between each virtual object and the target interactive object is displayed through the interactive screen, so that other users located in the first interactive space can watch the process of interaction between the virtual object in the second interactive space and the streamer.

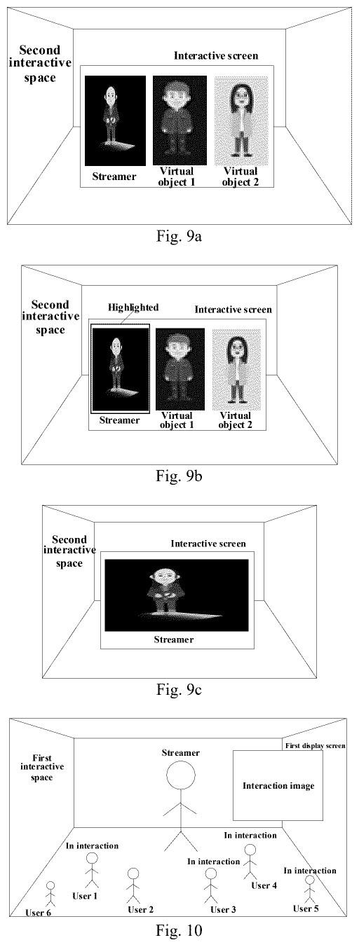

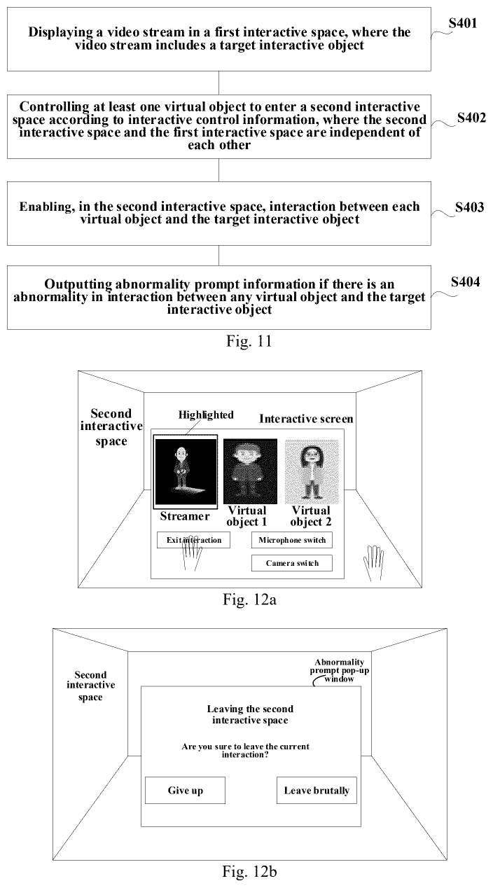

For example, as shown in FIG. 9a, when there are two virtual objects in the second interactive space, that is, the virtual object 1 and the virtual object 2, the voice co-hosting image of the streamer, the virtual object 1 and the virtual object 2 can be displayed on the interactive screen.

In the process of the streamer performing the co-hosting interaction with each virtual object, the streamer is speaking or performing for a period of time, and the virtual object is speaking or performing for another period of time. Therefore, in order to see intuitively whether the streamer or which virtual object is speaking or performing at the current moment, in the present application, in the process of displaying the interaction between each virtual object and the target interactive object on the interactive screen, the target object that is interacting (that is, currently speaking or performing) may be firstly determined. If the target object that is interacting is the streamer, the streamer is highlighted on the interactive screen. If the target object that is interacting is any virtual object, the virtual object is highlighted on the interactive screen, so that it can be determined who is currently speaking or performing according to the highlighted object.

Continuing to take FIG. 9a as an example for illustration, when it is detected that the target object that is currently performing the voice co-hosting interaction is the streamer, the streamer is highlighted on the interactive screen, for example, the border of the streamer image is highlighted, as shown in FIG. 9b. For another example, only the streamer image is displayed on the interactive screen, that is, the target object that is currently performing the voice co-hosting interaction is displayed in a single-person display manner, as shown in FIG. 9c.
S304, displaying an interaction image of each virtual object with the target interactive object on a first display screen in the first interactive space.

It should be understood that the first display screen may be a secondary screen other than the main screen that displays the live video stream of the streamer. In addition, the secondary screen may be a 2D screen.

In some embodiments, in the process of interaction between each virtual object in the second interactive space and the target interactive object, in the present application, the interaction image of each virtual object in the second interactive space with the target interactive object can be displayed through the first display screen in the first interactive space, so that other users who do not participate in the interaction can see not only the content of interaction between the streamer and the user participating in the interaction, but also the performance image of the streamer intuitively, for example, as shown in FIG. 10.

In the present application, the interaction image of each virtual object in the second interactive space with the target interactive object displayed on the first display screen in the first interactive space may be obtained by the following method.

In the first step, a target image acquired by a virtual camera in the second interactive space is acquired, where the target image is an interactive image of each virtual object when interacting with the target interactive object.

In the present application, the virtual camera is fixedly arranged in the second interactive space. The virtual camera is used to capture a real-time image of the interactive virtual object, and transmit the captured real-time image to a second display screen in the first interactive space through a Real-Time Communication (RTC) service, so as to lay a foundation for subsequently obtaining the interaction image of each virtual object in the second interactive space with the target interactive object. The second display screen is specifically a 2D large screen on site.

It should be noted that the clarity of the real-time image acquired by the virtual camera is at least 1080p, so as to ensure the clarity of the acquired real-time image.

That is, after the virtual object enters the second interactive space, the virtual camera located in the second interactive space will acquire image information of the virtual object in real time, and transmit the image to the second display screen in the first interactive space in real time. Therefore, the interaction process of the virtual object in the second interactive space can be displayed through the second display screen, so that the streamer can perform a response operation according to the interaction of the virtual object.

In the second step, the target image is displayed on the second display screen, and a target camera acquires the target image displayed on the second display screen and an interactive image of the target interactive object, where the target camera corresponds to the first display screen and the target interactive object.

In the third step, the interaction image of each virtual object with the target interactive object is generated according to the target image displayed on the second display screen and the interactive image of the target interactive object.

The target camera may be a 2D camera.

In some embodiments, the streamer is always located in the first interactive space in the interaction process, and the real-time image of the virtual object in the second interactive space is displayed on the second display screen in the first interactive space. Therefore, in the present application, the interactive image of the streamer and the target image displayed on the second display screen may be acquired by the target camera in the first interactive space. Furthermore, the interaction image of each virtual object with the target interactive object is generated according to the interactive image of the streamer acquired by the target camera and the target image displayed on the second display screen.

As an optional implementation, the interactive image of the streamer and the target image displayed on the second display screen may be spliced, to generate the interaction image of each virtual object with the target interactive object.

As another optional implementation, a streamer region may be cut out from the interactive image of the streamer, and then the streamer region and the target image displayed on the second display screen are spliced, to generate the interaction image of each virtual object with the target interactive object.

In addition to the above two generation manners, the interaction image of each virtual object with the target interactive object may also be generated by other manners, which will not be specifically limited here.

It should be noted that, when the streamer does not interact with the user in the first interactive space, the first display screen in the first interactive space may display a close-up performance image of the streamer, or a close-up image of the virtual object corresponding to any user in the first interactive space, or a background image and/or text information associated with the first interactive space, which will not be specifically limited here.

According to the technical solutions provided in the embodiments of the present application, the video stream is displayed in the first interactive space, and at least one virtual object is controlled to enter the second interactive space according to the interactive control information, and then each virtual object performs interaction with the target interactive object in the second interactive space. By adding an independent second interactive space on the basis of the first interactive space, the viewer can perform immersive interaction with the streamer in the independent second interactive space, thereby enriching the virtual interaction manners, improving the virtual interaction effect, and enhancing the interaction enthusiasm and interaction experience of the viewer. In addition, by providing the first display screen in the first interactive space and displaying the interaction image of each virtual object in the second interactive space with the target interactive object through the first display screen, other users who do not participate in the interaction can see not only the content of interaction between the streamer and the user participating in the interaction, but also the performance image of the streamer intuitively, thereby meeting different viewing requirements of the user in the process of watching the video stream, and improving the user experience.

In another optional implementation of the present application, any virtual object in the second interactive space may exit the second interactive space halfway due to network reasons or personal reasons in the process of interacting with the target interactive object. In view of this situation, in the present application, by outputting abnormality prompt information to the user participating in the interaction, the user can know the reason for exiting the interaction according to the prompt information and adjusts in time. The virtual interaction method provided in the embodiments of the present application will be further described below with reference to FIG. 11.

As shown in FIG. 11, the method may include the following steps.
S401, displaying a video stream in a first interactive space, where the video stream includes a target interactive object.
S402, controlling at least one virtual object to enter a second interactive space according to interactive control information, where the second interactive space and the first interactive space are independent of each other.
S403, enabling, in the second interactive space, interaction between each virtual object and the target interactive object.
S404, outputting abnormality prompt information if there is an abnormality in interaction between any virtual object and the target interactive object.

In the present application, an abnormality in the interaction between any virtual object located in the second interactive space and the target interactive object may include the following cases.

### Case 1

Any virtual object exits the second interactive space in the interaction process.

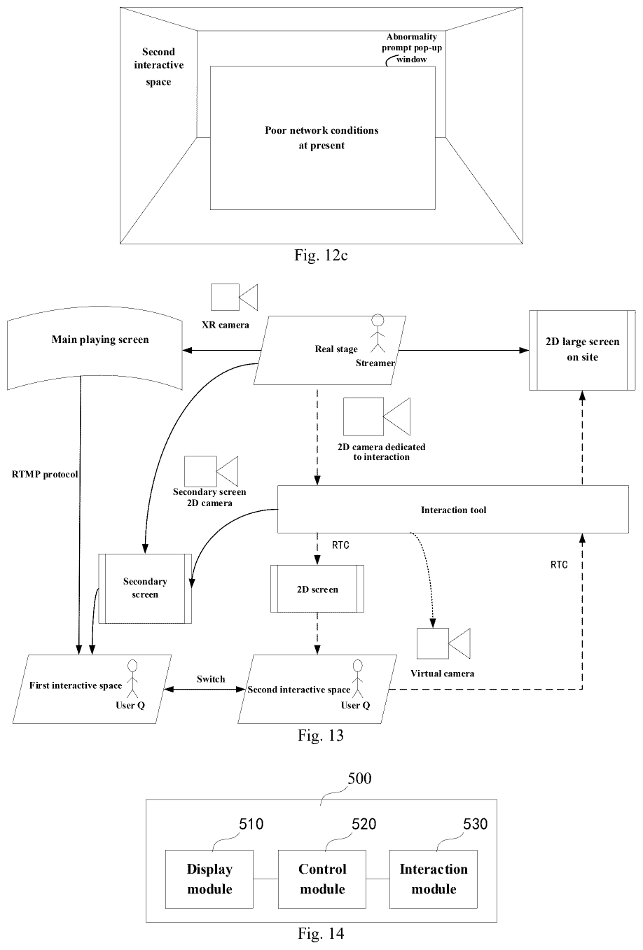

Exemplarily, as shown in FIG. 12a, if the virtual object 1 triggers an exit instruction by triggering an “Exit interaction” control presented in the second interactive space in the interaction process, it is determined that the user corresponding to the virtual object 1 wants to actively exit the second interactive space. At this time, an abnormality prompt pop-up window is displayed in the second interactive space. The abnormality prompt pop-up window may include retention theme information of “Leaving the second interactive space”, retention prompt information of “Are you sure to leave the current interaction?”, a control of “Give up”, and a control of “Leave brutally”. If the user corresponding to the virtual object 1 selects the control of “Leave brutally”, the user leaves the second interactive space, and a prompt of “Returning to the real spacetime, please wait” is displayed, as shown in FIG. 12b.

### Case 2

A network condition of a terminal device corresponding to any virtual object is poor in the interaction process.

Considering that the network is unstable in the actual use process, resulting in poor network conditions of the terminal device corresponding to the virtual object in the interaction process, which affects the interaction effect, at this time, the abnormality prompt information of “Poor network conditions at present” may be displayed in the second interactive space, as shown in FIG. 12c.

### Case 3

The network of the terminal device corresponding to any virtual object is disconnected in the interaction process.

The network used by the terminal device corresponding to the virtual object may experience abnormal data connection termination in the network connection due to problems of a local area network router or a line, which is referred to as network disconnection, resulting in the virtual object exiting the second interactive space. In view of this situation, the abnormality prompt of “An error is encountered and you have left the second interactive space” may be displayed in the first interactive space.

In another implementation, considering that no abnormality occurs in the whole interaction process, if the virtual object in the second interactive space and the target interactive object normally end the interaction, the virtual object returns from the second interactive space to the first interactive space, and the interaction end prompt information is displayed in the first interactive space. The interaction end prompt information may be, but is not limited to, the interaction has ended, and we look forward to your participation next time; the interaction has ended, and thank you for your participation, etc.

According to the technical solutions provided in the embodiments of the present application, the video stream is displayed in the first interactive space, and at least one virtual object is controlled to enter the second interactive space according to the interactive control information, and then each virtual object performs interaction with the target interactive object in the second interactive space. By adding an independent second interactive space on the basis of the first interactive space, the viewer can perform immersive interaction with the streamer in the independent second interactive space, thereby enriching the virtual interaction manners, improving the virtual interaction effect, and enhancing the interaction enthusiasm and interaction experience of the viewer. In addition, when an abnormality occurs in the interaction process, the abnormality prompt information is outputted to the user, so that the user can adjust in time, to ensure that the interaction can be carried out normally, thereby ensuring the interaction quality.

In order to more clearly illustrate the virtual interaction method provided by the present application, the following description will be given with reference to FIG. 13 as an example, which is described in detail below.

As shown in FIG. 13, assuming that the live streaming watching link is a solid line and the interaction link is a dotted line, when a user Q enters the first interactive space according to the watching requirement, the user Q can watch the performance of a streamer on a main playing screen in the first interactive space. The streamer performs on a real stage. That is, performance content of the streamer displayed on the main playing screen can be acquired in real time by a XR camera in the first interactive space. When a certain interactive section is reached, after the user Q participates in and is selected, the virtual object of the user Q will switch from the first interactive space to the second interactive space, that is, enter the second interactive space. Then, a streamer interaction image is displayed on a 2D display screen (the third display screen or the interactive screen) in the second interactive space, and the user Q interacts with the streamer in the second interactive space. The streamer interaction image can be acquired in real time by a 2D camera dedicated to interaction in the real stage scene and sent to the 2D display screen in the second interactive space.

In the process of the virtual object interacting with the streamer, a virtual camera in the second interactive space will acquire a interaction image of the virtual object corresponding to the user Q in real time, and transmit the interaction image to a 2D large screen on site (the second display screen) in the first interactive space in real time. Furthermore, the streamer on the real stage can respond according to the interaction image of the virtual object displayed on the 2D large screen on site. At the same time, a secondary screen 2D camera corresponding to a secondary screen (the first display screen) and the streamer in the real stage scene will acquire the real-time image of the streamer and the interaction image of the virtual object displayed on the 2D large screen, and display the content of interaction between the streamer and the user Q participating in the interaction generated according to the two types of images on the secondary screen.

In addition, after the interaction ends, the virtual object of the user Q can exit from the second interactive space, return to the first interactive space, and continue to watch the performance of the streamer.

That is, in the present application, by adding an independent second interactive space on the basis of the first interactive space, the viewer can perform immersive interaction with the streamer in the independent second interactive space, thereby enriching the virtual interaction manners, improving the virtual interaction effect, and enhancing the interaction enthusiasm and interaction experience of the viewer.

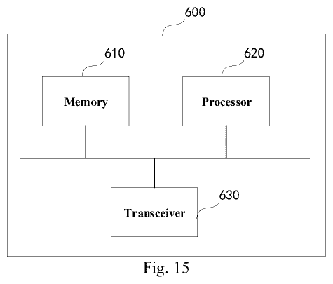

Referring to FIG. 14 below, a virtual interaction apparatus according to an embodiment of the present application is described. FIG. 14 is a schematic block diagram of a virtual interaction apparatus according to an embodiment of the present application.

As shown in FIG. 14, the virtual interaction apparatus 500 includes a display module 510, a control module 520, and an interaction module 530.

The display module 510 is configured to display a video stream in a first interactive space, where the video stream includes a target interactive object.

The control module 520 is configured to control at least one virtual object to enter a second interactive space according to interactive prompt information, where the second interactive space and the first interactive space are independent of each other.

The interaction module 530 is configured to enable, in the second interactive space, interaction between each virtual object and the target interactive object.

In one or more optional implementations of the embodiments of the present application, the interaction module 530 is specifically configured to:
perform voice co-hosting interaction between each virtual object and the target interactive object in the second interactive space; or
perform video co-hosting interaction between each virtual object and the target interactive object in the second interactive space.

In one or more optional implementations of the embodiments of the present application, the interaction module 530 is further configured to perform at least one of talent interaction and game interaction.

In one or more optional implementations of the embodiments of the present application, the control module 520 includes:
a pop-up window display unit configured to, if the current time is interaction time, display an interactive prompt pop-up window in the first interactive space, where the interactive prompt pop-up window includes at least interactive prompt information and an interactive confirmation option; and
a response control unit configured to control at least one virtual object to enter the second interactive space in response to a selection instruction for the interactive confirmation option.

In one or more optional implementations of the embodiments of the present application, the control module 520 further includes:
an instruction selection unit configured to select a target selection instruction from all acquired selection instructions, where the selection instruction is a selection instruction for the interactive confirmation option; and
correspondingly, the response control unit is specifically configured to:
control a virtual object corresponding to the target selection instruction to enter the second interactive space in response to the target selection instruction.

In one or more optional implementations of the embodiments of the present application, the instruction selection unit is specifically configured to:
determine whether a virtual object identification corresponding to each selection instruction is a preset identification; and
if the virtual object identification corresponding to any selection instruction is the preset identification, determine that the selection instruction is the target selection instruction.

In one or more optional implementations of the embodiments of the present application, the first interactive space is provided with a first display screen.

Correspondingly, the apparatus 500 further includes an interaction display module.

The interaction display module is configured to display an interaction image of each virtual object with the target interactive object on the first display screen.

In one or more optional implementations of the embodiments of the present application, the first interactive space is provided with a second display screen.

Correspondingly, the apparatus 500 further includes an image acquiring module, an image displaying module, and an interaction generating module.

The image acquiring module is configured to acquire a target image acquired by a virtual camera in the second interactive space, where the target image is an interactive image of each virtual object when interacting with the target interactive object.

The image displaying module is configured to display the target image on the second display screen, and acquire, by a target camera, the target image displayed on the second display screen and an interactive image of the target interactive object, where the target camera corresponds to the first display screen.

The interaction generating module is configured to generate the interaction image of each virtual object with the target interactive object according to the target image displayed on the second display screen and the interactive image of the target interactive object.

In one or more optional implementations of the embodiments of the present application, the apparatus 500 further includes a screen display module and an interaction display module.

The screen display module is configured to display a third display screen in the second interactive space.

The interaction display module is further configured to display the interaction image of each virtual object with the target interactive object on the third display screen.

In one or more optional implementations of the embodiments of the present application, the interaction display module is specifically configured to:
determine a target object that is interacting, where the target object is the target interactive object or any virtual object; and
highlight the target object on the third display screen.

In one or more optional implementations of the embodiments of the present application, the apparatus 500 further includes an information outputting module.

The information outputting module is configured to output abnormality prompt information if there is an abnormality in interaction between any virtual object and the target interactive object.

In one or more optional implementations of the embodiments of the present application, the abnormality in the interaction between any virtual object and the target interactive object comprises one of the following:
any virtual object exits the second interactive space in the interaction process; or
a network condition of a terminal device corresponding to any virtual object is poor in the interaction process; or
network of a terminal device corresponding to any virtual object is disconnected in the interaction process.

In one or more optional implementations of the embodiments of the present application, the information outputting module is specifically configured to display interaction end prompt information in the first interactive space if the interaction between the virtual object and the target interactive object ends.

In one or more optional implementations of the embodiments of the present application, the video stream is a live video stream.

It should be understood that the apparatus embodiment may correspond to the foregoing method embodiment, and reference may be made to the method embodiment for similar description. To avoid repetition, details are not described herein again. Specifically, the apparatus 500 shown in FIG. 14 may execute the method embodiment corresponding to FIG. 1, and the foregoing and other operations and/or functions of the respective modules in the apparatus 500 are respectively to implement the corresponding procedures in the respective methods in FIG. 1, which are not described in detail here for brevity.

The apparatus 500 according to the embodiments of the present application is described above from the perspective of functional modules with reference to the drawings. It should be understood that the functional modules may be implemented in the form of hardware, or may be implemented by instructions in the form of software, or may be implemented by a combination of hardware and software modules. Specifically, the steps of the first aspect method embodiment in the embodiments of the present application may be completed by hardware integrated logic circuits and/or instructions in the form of software in a processor, and the steps of the first aspect method disclosed in the embodiments of the present application may be directly embodied as being executed and completed by a hardware decoding processor, or being executed and completed by a combination of hardware and software modules in a decoding processor. Optionally, the software module may be located in a mature storage medium in the field, such as a random-access memory, a flash memory, a read-only memory, a programmable read-only memory, an electrically erasable programmable memory, a register, etc. The storage medium is located in a memory, and a processor reads information in the memory and completes the steps in the foregoing first aspect method embodiment in conjunction with its hardware.

FIG. 15 is a schematic block diagram of an electronic device according to an embodiment of the present application. As shown in FIG. 15, the electronic device 600 may include:
a memory 610 and a processor 620, where the memory 610 is configured to store a computer program and transmit the program code to the processor 620. In other words, the processor 620 may invoke and run the computer program from the memory 610 to implement the virtual interaction method in the embodiment of the present application.

For example, the processor 620 may be configured to execute the foregoing virtual interaction method embodiments according to instructions in the computer program.

In some embodiments of the present application, the processor 620 may include, but is not limited to, a general-purpose processor, a Digital Signal Processor (DSP), an Application Specific Integrated Circuit (ASIC), a Field Programmable Gate Array (FPGA) or other programmable logic device, a discrete gate or transistor logic device, a discrete hardware component, and the like.

In some embodiments of the present application, the memory 610 includes, but is not limited to, a volatile memory and/or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random-access memory (RAM) which serves as an external cache. By way of example but not limitation, many forms of RAM are available, such as a static random-access memory (Static RAM, SRAM), a dynamic random-access memory (Dynamic RAM, DRAM), a synchronous dynamic random-access memory (Synchronous DRAM, SDRAM), a double data rate synchronous dynamic random-access memory (Double Data Rate SDRAM, DDR SDRAM), an enhanced synchronous dynamic random-access memory (Enhanced SDRAM, ESDRAM), a synch link dynamic random-access memory (synch link DRAM, SLDRAM) and a direct rambus random-access memory (Direct Rambus RAM, DR RAM).

In some embodiments of the present application, the computer program may be divided into one or more modules, and the one or more modules are stored in the memory 610 and executed by the processor 620 to complete the virtual interaction method provided in the present application. The one or more modules may be a series of computer program instruction segments capable of completing specific functions, and the instruction segments are used to describe the execution process of the computer program in the electronic device.

As shown in FIG. 15, the electronic device 600 may further include:
a transceiver 630, and the transceiver 630 may be connected to the processor 620 or the memory 610.

The processor 620 may control the transceiver 630 to communicate with other devices, specifically, to send information or data to other devices, or receive information or data sent by other devices. The transceiver 630 may include a transmitter and a receiver. The transceiver 630 may further include an antenna, and the number of the antennas may be one or more.

It should be understood that various components in the electronic device are connected through a bus system, where the bus system includes a power bus, a control bus, and a status signal bus in addition to a data bus.

The present application also provides a computer-readable storage medium for storing a computer program, where the computer program cause a computer to execute the virtual interaction method described in the foregoing method embodiments.

The embodiments of the present application further provide a computer program product including program instructions, where when the program instructions are run on an electronic device, the electronic device is caused to execute the virtual interaction method described in the foregoing method embodiments.

When implemented in software, it may be implemented in whole or in part in the form of a computer program product. The computer program product includes one or more computer instructions. When the computer program instructions are loaded and executed on a computer, the procedures or functions according to the embodiments of the present application are generated in whole or in part. The computer may be a general-purpose computer, a special-purpose computer, a computer network, or other programmable devices. The computer instructions may be stored in a computer-readable storage medium or transmitted from one computer-readable storage medium to another computer-readable storage medium, for example, the computer instructions may be transmitted from one website, computer, server or data center to another website, computer, server or data center in a wired (for example, coaxial cable, optical fiber, digital subscriber line (DSL)) or wireless (for example, infrared, wireless, microwave, etc.) manner. The computer-readable storage medium may be any available medium that can be accessed by a computer or a data storage device such as a server or a data center integrating one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can appreciate that the modules and algorithm steps of the various examples described in connection with the embodiments disclosed herein can be implemented in electronic hardware, or a combination of computer software and electronic hardware. Whether these functions are performed in hardware or software depends on the specific application and design constraints of the technical solutions. Professionals and technicians can use different methods for each specific application to implement the described functions, but such implementation should not be considered to be beyond the scope of the present application.

In the several embodiments provided by the present application, it should be understood that the disclosed system, apparatus, and method may be implemented in other manners. For example, the above-described apparatus embodiments are only schematic. For example, the division of the modules is only a logical function division, and there may be other division manners in actual implementation. For example, multiple modules or components may be combined or integrated into another system, or some features may be omitted or not executed. In addition, the mutual coupling or direct coupling or communication connection shown or discussed may be indirect coupling or communication connection through some interfaces, apparatuses, or modules, which may be electrical, mechanical, or other forms.

The modules described as separate parts may or may not be physically separated, and the parts displayed as modules may or may not be physical modules, that is, they may be located in one place or may be distributed to multiple network units. Some or all of the modules may be selected according to actual needs to achieve the purpose of the solution of the embodiment. For example, the functional modules in the embodiments of the present application may be integrated into one processing module, or the modules may exist individually physically, or two or more modules may be integrated into one module.

The above is only a specific implementation of the present application, but the protection scope of the present application is not limited to this. Any person skilled in the technical field can easily think of changes or replacements within the technical scope disclosed in the present application, which should be covered within the protection scope of the present application. Therefore, the protection scope of the present application should be subject to the protection scope of the claims.

1. A virtual interaction method, comprising:
displaying a video stream in a first interactive space, wherein the video stream comprises a target interactive object;
controlling at least one virtual object to enter a second interactive space according to interactive control information, wherein the second interactive space and the first interactive space are independent of each other; and
enabling, in the second interactive space, interaction between each virtual object and the target interactive object.

2. The method according to claim 1, wherein the enabling, in the second interactive space, interaction between each virtual object and the target interactive object comprises:
enabling voice co-hosting interaction between each virtual object and the target interactive object in the second interactive space; or
enabling video co-hosting interaction between each virtual object and the target interactive object in the second interactive space.

3. The method according to claim 2, wherein the video co-hosting interaction between each virtual object and the target interactive object in the second interactive space comprises at least one of talent interaction or game interaction.

4. The method according to claim 1, wherein the controlling at least one virtual object to enter the second interactive space according to the interactive control information comprises:
in response to that the current time is interaction time, displaying an interactive prompt pop-up window in the first interactive space, wherein the interactive prompt pop-up window comprises at least interactive prompt information and an interactive confirmation option; and
controlling at least one virtual object to enter the second interactive space in response to a selection instruction for the interactive confirmation option.

5. The method according to claim 4, wherein before the controlling at least one virtual object to enter the second interactive space in response to the selection instruction for the interactive confirmation option, the method further comprises:
selecting a target selection instruction from all acquired selection instructions, wherein the selection instruction is a selection instruction for the interactive confirmation option; and
wherein the controlling at least one virtual object to enter the second interactive space in response to the selection instruction for the interactive confirmation option comprises:
controlling a virtual object corresponding to the target selection instruction to enter the second interactive space in response to the target selection instruction.

6. The method according to claim 5, wherein the selecting the target selection instruction from all acquired selection instructions comprises:
determining whether a virtual object identification corresponding to each selection instruction is a preset identification; and
in response to that the virtual object identification corresponding to any selection instruction is the preset identification, determining that the selection instruction is the target selection instruction.

7. The method according to claim 1, wherein the first interactive space is provided with a first display screen; and
the method further comprises:
displaying an interaction image of each virtual object with the target interactive object on the first display screen.

8. The method according to claim 7, wherein the first interactive space is provided with a second display screen; and
before the displaying the interaction image of each virtual object with the target interactive object on the first display screen, the method further comprises:
acquiring a target image acquired by a virtual camera in the second interactive space, wherein the target image is an interactive image of each virtual object when interacting with the target interactive object;
displaying the target image on the second display screen, and acquiring, by a target camera, the target image displayed on the second display screen and an interactive image of the target interactive object, wherein the target camera corresponds to the first display screen; and
generating the interaction image of each virtual object with the target interactive object according to the target image displayed on the second display screen and the interactive image of the target interactive object.

9. The method according to claim wherein after the controlling at least one virtual object to enter the second interactive space according to the interactive control information, the method further comprises:
displaying a third display screen in the second interactive space; and
displaying the interaction image of each virtual object with the target interactive object on the third display screen.

10. The method according to claim 9, wherein the displaying the interaction image of each virtual object with the target interactive object on the third display screen comprises:
determining a target object that is interacting, wherein the target object is the target interactive object or any virtual object; and
highlighting the target object on the third display screen.

11. The method according to claim 1, wherein the method further comprises:
outputting abnormality prompt information in response to that there is an abnormality in interaction between any virtual object and the target interactive object.

12. The method according to claim 11, wherein the abnormality in the interaction between any virtual object and the target interactive object comprises one of the following:
any virtual object exits the second interactive space in the interaction process;
a network condition of a terminal device corresponding to any virtual object is poor in the interaction process; or
network of a terminal device corresponding to any virtual object is disconnected in the interaction process.

13. The method according to claim 1, wherein the method further comprises:
displaying interaction end prompt information in the first interactive space in response to that the interaction between the virtual object and the target interactive object ends.

14. The method according to claim 1, wherein the video stream is a live video stream.

15. (canceled)

16. An electronic device, comprising:
a processor and a memory, wherein the memory is configured to store a computer program, and the processor is configured to invoke and run the computer program stored in the memory to execute a virtual interaction method, comprising:
displaying a video stream in a first interactive space, wherein the video stream comprises a target interactive object;
controlling at least one virtual object to enter a second interactive space according to interactive control information, wherein the second interactive space and the first interactive space are independent of each other; and
enabling, in the second interactive space, interaction between each virtual object and the target interactive object.

17. A non-transitory computer-readable storage medium, configured to store a computer program, wherein the computer program enables a computer to execute a virtual interaction method, comprising:
displaying a video stream in a first interactive space, wherein the video stream comprises a target interactive object;
controlling at least one virtual object to enter a second interactive space according to interactive control information, wherein the second interactive space and the first interactive space are independent of each other; and
enabling, in the second interactive space, interaction between each virtual object and the target interactive object.

18. (canceled)

19. (canceled)

20. The electronic device according to claim 16, wherein the enabling, in the second interactive space, interaction between each virtual object and the target interactive object comprises:
enabling voice co-hosting interaction between each virtual object and the target interactive object in the second interactive space; or
enabling video co-hosting interaction between each virtual object and the target interactive object in the second interactive space.

21. The electronic device according to claim 20, wherein the video co-hosting interaction between each virtual object and the target interactive object in the second interactive space comprises at least one of talent interaction or game interaction.

22. The electronic device according to claim 16, wherein the controlling at least one virtual object to enter the second interactive space according to the interactive control information comprises:
in response to that the current time is interaction time, displaying an interactive prompt pop-up window in the first interactive space, wherein the interactive prompt pop-up window comprises at least interactive prompt information and an interactive confirmation option; and
controlling at least one virtual object to enter the second interactive space in response to a selection instruction for the interactive confirmation option.

23. The electronic device according to claim 22, wherein before the controlling at least one virtual object to enter the second interactive space in response to the selection instruction for the interactive confirmation option, the method further comprises:
selecting a target selection instruction from all acquired selection instructions, wherein the selection instruction is a selection instruction for the interactive confirmation option; and
wherein the controlling at least one virtual object to enter the second interactive space in response to the selection instruction for the interactive confirmation option comprises:
controlling a virtual object corresponding to the target selection instruction to enter the second interactive space in response to the target selection instruction.
